(19) United States
(12) Patent Application Publication
(10) Pub. No.: US 2005/0161845 A1
(43) Pub. Date: Jul. 28, 2005

(54) Production and shaping of shaped bodies by means of low-temperature cooling an drying processes

(76) Inventor: Alfred Haas, Eppelheim (DE)

Correspondence Address: Stephen D Scanlon;Jones Day, North Point, 901 Lakeside Avenue, Cleveland, OH, 44114, US

(21) Appl. No.: 10/497,824

(22) PCT Filed: Dec. 9, 2002
(86) PCT No.: PCT/EP02/13920

(30) Foreign Application Priority Data
Dec. 10, 2001 (DE) 101 60 597.8
Mar. 14, 2002 (DE) 102 11 260.6

(51) Int. Cl. B29B 9/00

(52) U.S. Cl. 264/5; 425/6

(57) ABSTRACT

The present invention relates to a process for producing and shaping shaped bodies, in particular heterogeneous catalysts, by means of low-temperature cooling processes, characterized in that a settable and flowable composition, preferably inorganic in nature, for example, a suspension of solids, is introduced as droplets of the desired shape and size into a low-temperature coolant and the frozen droplets are then converted by means of drying and/or calcination processes into the corresponding mechanically stable, solid shaped bodies. The present invention further relates to the shaped body itself which is obtainable by the processes of the invention and the use of the process of the invention for producing and shaping shaped bodies.

The present invention relates to a process for producing and shaping shaped bodies, in particular heterogeneous catalysts, by means of low-temperature cooling processes, characterized in that a settable and flowable composition, preferably inorganic in nature, for example a suspension of solids, is introduced as droplets of the desired shape and size into a low-temperature coolant and the frozen droplets are then converted by means of drying and/or calcination processes into the corresponding mechanically stable, solid shaped body. The present invention further relates to the shaped body which is obtainable by the process of the invention and to the use of the shaped body of the invention for a variety of industrial applications.

The present invention is essentially concerned with the production of shaped bodies, i.e. three-dimensional bodies, which are produced from a settable and flowable composition which comprises at least one binder together with other components. The shaped bodies produced in this way should preferably, but not necessarily, be inorganic in nature and can be porous or nonporous bodies, with preference being given to porous bodies. The shaped bodies can be used, for example, as granular materials, absorbates, packing elements, transport materials, storage materials, support substances, ceramic materials, catalysts or loose material. All other possible uses of shaped bodies of the size and shape obtainable according to the invention are likewise encompassed.

By way of example, the production of the shaped bodies of the invention for applications in heterogeneous catalysis, in particular, will be described below. However, this does not imply that the shaped bodies of the invention cannot also be produced and used for other purposes, e.g. those mentioned by way of example in the preceding paragraph.

Heterogeneous catalysts, i.e. typically catalytically active, solid shaped bodies which accelerate the reaction of gaseous or liquid reactants to form likewise liquid or gaseous products or make possible reactions of this type which would otherwise not occur at all, are of great importance in chemical engineering, including biochemical, pharmaceutical and related applications.

The action of heterogeneous catalysts, i.e. particularly their activity and selectivity, depends not only on the composition and the structure of the catalytically active centres and the surface area available to the reactants but also, in particular, on macrokinetic factors such as mass transfer and/or heat transport in and/or through the shaped catalytic body. These factors are determined by geometric parameters of the shaped body, for example its external shape and dimensions, pore size and pore size distribution. Accordingly, control of these parameters and the possibility for them to be varied within a wide range are of particular importance.

The production of heterogeneous catalysts, whether as powder, as monolithic solid bodies, as a thin film or as round shaped bodies (beads, pellets, granules), can be carried out by a variety of processes, with the choice of the process being determined by the specific requirements of the particular application intended.

Heterogeneous catalysts can be divided into three different categories on the basis of the type of structure which they have: (i) all-active catalysts, i.e. catalysts in which the active composition is distributed uniformly throughout the entire catalyst volume, (ii) impregnated catalysts in which the active composition is typically present in the pores of support bodies, and (iii) coated catalysts in which the active composition is located on the outer surface of a support or in which, conversely, the active composition is located in the interior and is protected by an outer shell. The term “coated catalysts” encompasses all coated substrates.

For the purposes of the present invention, which is concerned with shaped bodies, the case (i) of an all-active catalyst is of particular interest. Such all-active catalysts are produced, for example, by precipitation processes of the prior art (cf., for example, Handbook of Heterogeneous Catalysis, Vol. 1, pp. 73-85, Verlag Chemie, Weinheim, 1997), in which, for example, aqueous, acidic metal salt solutions are precipitated by means of basic solutions. While this first process step is still relatively easy to automate, e.g. with the aid of liquid metering robots, the following steps, viz, washing, shaping, drying, milling, sieving, etc., can no longer be readily automated, i.e. when a large number of catalyst particles of a defined size are to be produced, as is the case, for example, for combinatorial catalyst research, this can only be achieved with the expenditure of a great deal of time.

As an alternative to precipitation processes, spray drying processes in which binder, filler and, depending on the application, a catalytically active material, e.g. a zeolite, are suspended in an aqueous medium and are subsequently spray dried, i.e. sprayed from a nozzle into air, are used in industrial applications. Such processes initially give particles having a diameter of a few μm. The shaped bodies produced in this way have the correct size for use in fluidized-bed and moving-bed reactors. Larger particles can be obtained only by agglomeration of the still liquid small particles, with factors such as the geometry and the size of the drying chambers determining the diameter of the agglomerated particles. To obtain particles or shaped bodies which are of a size suitable for, for example, applications in fixed-bed reactors or in combinatorial catalysis, i.e. which have, for example, diameters of from 500 μm to 5 mm, drying chambers having a height of more than 5 m are required. These are thus dimensions which are no longer practical for catalyst research and catalyst production on a laboratory scale.

As an alternative, shaped bodies which have a size larger than 10 μm and which in principle do not have an upper limit to their size can be produced on a laboratory scale by spray granulation processes. In this process, particles having a diameter of from 5 to 10 μm are generated by means of a two-fluid nozzle, and layer upon layer of settable composition is then applied to them in a fluidized bed and they are then dried in a “mild” profile. The disadvantages of this process are that a large batch is necessary to produce the particles, that the yields are comparatively small (<50%), that the particles have a broad distribution in respect of their external shape and are, in particular, not pronouncedly spherical and that the settability of the composition used in the process has to be high, i.e. many compositions which are in principle settable cannot be shaped into shaped bodies by this process.

For applications in which the shaped bodies (spheres) have to have a diameter of a number of millimetres, the suspensions are therefore often not spray dried but instead dried directly, for example in a laboratory microwave oven, The dried catalyst cake is then broken up, comminuted in a laboratory mill and the desired fraction is finally obtained by vibration sieving (cf., for example, DE 10134871). It seems likely that such a process of the prior art would be very difficult to automate and also very time-consuming and costly. In addition, there is a risk that sensitive constituents of the shaped body, for example the active centres, could have their activity reduced or be entirely destroyed by the mechanical steps which are associated with continual input of energy into the system.

An alternative to the abovementioned methods for producing shaped bodies is known from another field, namely the coolant industry. Here, viscous liquids are frozen or pelletized in a controlled fashion (cf., for example, DE 37 11 169). There, the essentially destruction-free conversion of sensitive substances, for example biologically active components, organic substances or foodstuffs, into the frozen state is the main intention. This is achieved by controlled dropwise introduction of a composition into a cooling bath, which is typically operated directly or indirectly by means of liquid nitrogen. Examples of “snap” freezing, i.e. the particularly fast conversion of a sensitive foodstuff or biologically active substance, i.e. in any case a water-containing substance, into the frozen state without the formation of macroscopic ice crystals and the associated structural change or destruction of the surrounding matrix, have been described for liquid egg (cf. GB 1 376 972), living cells such as bacterial suspensions (cf. DE 37 11 169) or fruit juice pellets or ice-cream pellets (cf. DE 199 56 167).

An apparatus for pelletizing or granulating a liquid or paste-like material, preferably ice cream or other foodstuffs, by means of a liquid coolant is described in DE 198 37 600. This apparatus makes it possible to produce large-volume pellets, as is advantageous for the preservation of ice cream. This document is concerned exclusively with the snap freezing of liquid or paste-like materials for a limited period of time, with the aim of preservation or storage. A similar situation applies to the above-mentioned DE 199 56 167, which is concerned with the implementation of a directed forced flow in a coolant bath, and to U.S. Pat. No. 4,655,047, which relates to a process in which a stirring screw is used in the coolant bath to avoid turbulence.

The object of all the abovementioned processes and processes of the prior art for freezing liquid or paste-like compositions is essentially unaltered preservation of the state which is present before freezing. The process has to be carried out so that the original state is restored essentially unaltered after thawing. The processes for quick preservation therefore provide no teaching in respect of the production, shaping and further processing of (thermally) stable shaped bodies in general. In particular, possible processes of pretreatment and after-treatment, e.g. drying, setting or calcination, which are essential for producing stable shaped bodies, are not disclosed or only suggested.

It can therefore be stated that the production and shaping of shaped bodies by freezing and with a view to a drying or setting step is definitely not prior art. This applies particularly to the production and shaping of inorganic and/or catalytically active shaped bodies, especially all-active catalytic bodies. The existing processes for producing inorganic shaped bodies which form part of the prior art, i.e., in particular, precipitation, spray drying, granulation or milling processes, i.e. processes without a freezing step but possibly with a drying step, each suffer from at least one of the following disadvantages: (i) sensitive shaped bodies cannot be produced because of mechanical treatment steps such as milling, classification, vibration, etc., (ii) not all process steps can be automated or be integrated into an automated overall process, (iii) it is possible to obtain only shaped bodies (pellets, beads, granules) in the sub-millimetre range but not shaped bodies having diameters of a number of millimetres, as are required, in particular, in combinatorial, high-throughput catalyst research, (iv) the size of the plants necessary for producing the desired shaped bodies far exceeds the capacities which are customary and appropriate for work on a laboratory scale, (v) the process cannot be carried out using milligram batches and (vi) cannot be applied to only weakly settable compositions.

It is therefore an object of the present invention to produce shaped bodies, preferably catalysts, in a size which can be chosen freely, preferably in the range from 5 μn and 50 mm, and in a shape which can be chosen freely, preferably a spherical shape, with the process for producing and shaping not including any mechanical processing steps which could adversely affect the integrity of the shaped bodies, in particular no shaping steps to be implemented subsequently, for example milling or division. Furthermore, it is part of the object of the invention for the process to be able to be fully automated and integrated into other processes.

The object of the invention is achieved by a settable and flowable composition which is preferably inorganic in nature firstly being broken up into droplets and then quickly frozen and defined in its shape in a further step with the aid of a low-temperature coolant. The frozen droplets obtained in this way are subsequently further treated and after-treated, in particular with inclusion of a drying step, e.g. via vacuum sublimation (freeze drying), and an optional calcination step (firing).

The achievement of the object of the invention is not restricted to, but is particularly directed at, the production of inorganic shaped bodies which are suitable as catalysts for combinatorial catalyst research. Important advantages of the process of the invention for the production of catalysts are: (i) high yields of up to 90% are possible, (ii) very small batches are possible, down to the milligram range, (iii) the process is simple and flexible and it can be carried out quickly and it is possible to alternate between various substances without complicated cleaning and process steps, (iv) even weakly setting compositions can be aggregated to form shaped bodies, (v) all characteristics of the shaping and production processes of the prior art, e.g. of spray drying or spray granulation, are achieved while at the same time allowing much smaller apparatus dimensions and simpler handling.

For the purposes of the present invention, a distinction is made between five different states in which the settable and flowable composition, i.e. the starting substance, can be present: (i) as a settable and flowable composition as such, (ii) as a droplet, (iii) as a shaped droplet, (iv) as a frozen droplet and (v) as a shaped body. These states are defined at the relevant point in the following description of the process of the invention for producing a shaped body.

The term “settable and flowable composition” as used for the purposes of the present invention refers to any conceivable substance which can be frozen and set to give a shaped body for the purposes of the invention and which, furthermore, contains inorganic constituents in a proportion of from 0 to 100% by weight, with this proportion preferably being from 10 to 100% by weight and particularly preferably from 75 to 100% by weight.

Such a settable and flowable composition accordingly contains at least one binder. Self-binding compositions, e.g. gel-forming systems, are thus explicitly included among settable and flowable compositions. In a preferred embodiment, the settable and flowable composition contains at least one binder and a framework substance. In a particularly preferred embodiment, the sellable and flowable composition contains at least one binder and a framework substance and a catalytically active substance. The addition of further auxiliaries, active ingredients and additives to any of the abovementioned possible substance combinations is likewise conceivable.

In a preferred embodiment, the settable and flowable composition is kept flowable by the addition of water, i.e. a settable and flowable composition is, in particular, a suspension of the preferably pulverulent constituents—binder and optionally framework substance(s) and optionally catalytically active substance(s) and optionally additives, active ingredients and auxiliaries—in water or an aqueous solution.

It is furthermore conceivable for the settable and flowable composition to be in a form other than a suspension, for example to be in the form of an emulsion, dispersion, sol, gel, sol/gel, colloid, liquid crystals or any combination or mixture thereof or with a suspension.

As binders, it is in principle possible to use all solid particles having a diameter in the submicron range. The binder(s) to be used for the settable and flowable composition is/are selected from the following group, without being restricted to this group: inorganic polymers having a tendency to form bridges; metal salts, preferably those having a low content of water of crystallization; polyoxometalates; pyrogenic or colloidal metal oxides; polymers, in particular hydroxycellulose; graphite and carbon black; alkoxides; organic compounds of the main group elements and transition elements. Combinations of two or more substances from this group or combinations with other substances not listed here are likewise conceivable. In a particularly preferred embodiment, inorganic polymers which are capable of bridge formation are used as binders, with particular preference being given to aluminium oxyhydroxychloride sols having a molar ratio of A1:C1 ranging from 1:2 to 2:1 with compostions around 2:1 being particularly preferred.

The framework substance(s) which may optionally be used for the settable and flowable composition is/are selected from the following group, without being restricted thereto: oxides, oxide mixtures, mixed oxides, silicates, kaolins, aluminosilicates, aluminophosphates, mixed oxides of the main group elements and transition elements, in particular the transition elements, alkali metal oxides and alkaline earth metal oxides, glass-forming oxides and mixtures thereof, lipids, amphiphiles, colloids and polymers and also all conceivable mixtures and combinations of these substances. In a preferred embodiment, kaolin is used as framework substance.

Furthermore, the introduction of fibrous or platelet-like constituents can be advantageous and it is conceivable for the framework-forming materials to be introduced as precursor materials which are liberated or transformed only under processing conditions. An example which may be mentioned is the use of alkoxides, e.g. TEDS (tetraethyl orthosilicate), and its hydrolysis to SiO₂ containing compounds under setting conditions or under other conditions which lead to condensation.

The catalytically active substance(s) which may optionally be used for the settable and flowable composition is/are selected from the following group, without being restricted thereto: oxides containing at least one silicate phase, with part of the silicon being able to be replaced by at least one other element or combinations of other elements. Preference is given to zeolites. In a particulady preferred embodiment, zeolites of the ZSM type are used as catalytically active substances.

The organic or inorganic auxiliary or auxiliaries which may optionally be used for the settable and flowable composition is/are selected from the following group, without being restricted thereto: lubricants, fluidizers, fillers, surfactants, solvents and surface-active agents. Combinations of two or more substances from this group or combinations with other substances not listed here are likewise conceivable.

Furthermore, it is conceivable for the catalytically active substance and binder and framework substance or catalytically active substance and binder or catalytically active substance and framework substance or binder and framework substance to be identical, i.e. one substance can have more than one or even all of the abovementioned functions.

The above-defined settable and flowable composition, whose possible compositions have been described above, is subjected to at least the following steps in the process of the invention for producing the shaped body of the invention:
(1) Division of a sellable and flowable composition into droplets;
(2) Freezing of the droplets with the aid of a coolant;
(3) Drying and calcination or drying or calcination of the frozen droplets.

The steps (1) to (3) and also the steps (1′), (1″) and (T) defined below can be repeated and/or permutated as often as desired, although preference is given to carrying out step (1), optional step (T), optional step (1′), optional step (T), optional step (1″), optional step (T), step (2), optional step (1), step (3), optional step (T) any number of times but in precisely this order and without permutation.

The division of the settable and flowable composition can be carried out by all methods which lead to a defined portion of the settable and flowable composition being separated off. This portion is referred to as droplets for the purposes of the invention.

The term “droplets” as used for the purposes of the present invention refers to a closed, i.e. physically separated, portion of the settable and flowable composition which has been separated off, for example, by one of the methods of division mentioned below. A droplet is, in contrast to a frozen droplet or the shaped body, characterized in that it is soluble in the flowable state and accordingly can be subjected to a shaping step. In contrast to the everyday usage of the term, a droplet does not necessarily have a “drop shape”. Rather, any conceivable shape of the portion which has been separated off is explicitly encompassed, e.g., in particular, platelets, rods or irregular geometries.

The division of the settable and flowable composition according to the invention can be carried out by all methods which are generally known to a person skilled in the art for the division of a flowable composition. In a preferred embodiment, division is carried out simply by setting the opening of a dropwise addition device, e.g. a hose with a clamp or a capillary with a valve. The size of the opening can be varied so that a droplet of the desired size drips from the opening. However, particularly in the case of highly viscous fluids, division is only possible with additional introduction of energy, e.g. by means of compressed gases, indirect pressure methods, ultrasound or mechanical processes.

In a further preferred embodiment, a nozzle is used for the division step, and this is typically referred to as “spraying”. In a preferred embodiment, use is made of a two-fluid nozzle in which the liquid to be sprayed is broken up by a spraying gas. Here, a large velocity gradient between the gas and liquid is necessary and the magnitude of this gradient determines the size of the sprayed particles.

In a particularly preferred embodiment, an ultrasonic disintegrator is used for dividing the bindable and flowable composition. This is an atomizer unit which makes use of piezoelectrically generated ultrasound, i.e. longitudinal impulse fluctuations in a converter medium. The fluid which is fed into a fluid channel comes into direct contact with the converter vibrating at high frequencies and is divided or atomized. The size of the droplets brined can be set by adjustment of the ultrasound frequency. Thus, for example, droplets having a diameter of 90 μm are obtained at 20 kHz and droplets having a diameter of 45 μm are obtained at 40 kHz.

In a particularly preferred embodiment, the settable and flowable composition is divided with the aid of a jet cutter. This is a rotating array of cutting wires which are mounted concentrically about an axis of rotation. Constant laminar flow of the settable and flowable composition to be divided is an important prerequisite for the generation of droplets having a narrow size spectrum. Division gives firstly rod-shaped droplets which are transformed into spheres as they fall because of the surface tension. The droplet shape can thus be varied to some extent as a function of the distance the droplets fall between division and freezing. The size of the droplets can be set via the frequency of rotation of the array of wires.

After the settable and flowable composition has been divided, the resulting droplet is transported from the division apparatus by means of a transport process and is processed further. The term “transport process” as used for the purposes of the invention refers quite generally to the transport of material, here settable and flowable composition, droplet, shaped droplet, frozen droplet or shaped body, from one point in space to another. The transport step occurring at this juncture is, for example, the transport of a droplet from the division apparatus to the cooling apparatus.

For this transport process, as for any other transport process used for the purposes of the invention, all physical, but in particular mechanical, transport mechanisms known to a person skilled in the art are conceivable. In this specific case of the transport of the droplet coming from the division apparatus directly into the cooling apparatus, particular preference is given to. transport under the action of gravitational forces, i.e. allowing the droplet to fall. For the purposes of the present invention, such an essentially natural transport is not specifically identified as a separate process step but is instead regarded as part of the division step (1). In contrast, any transport process which does not occur as a result of gravity is regarded as an independent transport step, as defined below.

In this context, it may be pointed out that the transport of a flowable composition into a cooling apparatus by allowing droplets to fall leads to a droplet shape which is easily deformed by gravitational forces but is essentially spherical, and is consequently also referred to as “drop shape”, if the transport path is sufficiently long. The shape of the droplet can be varied to some extent via the length of the distance through which it falls, e.g. as shown above for the case of the jet cutter.

If, however, shaped bodies which deviate significantly from a drop shape are desired, the droplet has to be subjected to an external force field to shape it before it is frozen. This shaping can be combined with the transport process, e.g. by use of moving mechanical elements which effect both transport and shaping. In this sense, the above-defined division step (1) can be followed by an additional, optional shaping step (1′):

(1′) shaping of the droplet of settable and flowable composition formed by division.

This results, according to the invention, in a shaped droplet. For the purposes of the present invention, preference is given to shaping always being carded out, unless it has in any case already taken place as a result of the division and/or the sphere formation process as the droplet falls, prior to solidification, i.e. in the fluid state, and not afterwards on the set and possibly even cured shaped body using complicated mechanical means such as milling and sieving, as is customary in the prior art.

Each transport process can be carried out at any juncture in the overall process of the invention and as often as desired, typically, for example, for carrying the frozen droplets by means of a conveyor belt from the cooling bath and for introducing them into the drying and/or calcination unit. Such a transport step is defined as follows:

(T) transport of the settable and flowable composition or of portions thereof from one point in space to another, during which the settable and flowable composition can be present in any state, i.e. unchanged as a mass, as a droplet, as a shaped droplet, as a frozen droplet or as a shaped body.

Further transport methods apart from transport by means of gravity can be selected from the following group, without being restricted to this group: use of carrier or transport fluids which are not miscible with the settable and flowable composition, force fields in general, i.e. direct or indirect transmission of momentum, sonic fields, electrostatic methods, magnetic methods (if the materials are susceptible to a magnetic field and/or electrically conductive) and any combinations of the above methods. Among mechanical methods, preference is given to chutes, impellers, screws, wheels, combs, conveyor belts, “rotating doors” (e.g. paddle wheels), pickers (e.g. pick-and-place devices), tongs, grabbers, carts, hoses and combinations thereof.

In the context of transport processes such as introduction, ongoing transport or discharge of the droplets, shaped droplets, frozen droplets or shaped bodies of the invention into/in/from the cooling apparatus or the cooling bath is subject matter of the publications DE 199 56 167, DE 196 48 394, U.S. Pat. No. 4,655,047 and WO 87/04903, which sic all concerned with technical developments of the transport processes of mass units on introduction into or transport in low-boiling, liquefied coolants and are fully incorporated by reference into the present patent application.

After division of the settable and flowable composition and production and optionally shaping of a droplet or shaped droplet according to the invention, the latter is then frozen in a low-temperature cooling apparatus. The only restriction placed on the low-temperature cooling apparatus used according to the invention is that it has to contain a low-temperature coolant suitable for freezing the droplet. In the present context, freezing is the transition from the liquid state to the solid state. If suspensions are used, then the freezing point of the solvent, e.g. water, is the critical factor; here, it has to be taken into account that the freezing point is lowered compared to the pure solvent by the presence of dissolved material. For the purposes of the invention, any process which makes use of a low-temperature coolant and/or a low-temperature cooling apparatus is referred to as a low-temperature cooling process.

For the purposes of the invention, a low-temperature coolant is any medium which when brought into contact with the droplet of the invention causes it to solidify to form a solid body. The simplest embodiment, and also a preferred embodiment, consists of an insulating vessel, e.g. a Dewar vessel, which contains a low-boiling, liquefied coolant and into which the droplet is introduced. In a more preferred embodiment, the cooling bath is present in a closed vessel which, inter alia, allows the recirculation of vaporized coolant and/or the regulated discharge and/or monitoring of any poisonous or suffocating coolant vapour.

All auxiliaries and process steps of refrigeration, low-temperature refrigeration and cryogenic engineering which are known from the prior art and are necessary for the construction and operation of a low-temperature cooling unit to be used according to the invention can be used for all embodiments mentioned in this application. These auxiliaries and process steps are selected from the following group, but are not restricted thereto: cold-resistant valves, insulated feed and discharge lines, insulation devices generally, temperature and gas sensors, established techniques and safety measures for handling low-boiling, liquefied coolants, and also, in particular, knowledge from materials research in respect of the choice of materials having appropriate coefficients of thermal conductivity and thermal expansion.

The freezing of the droplets can in principle be carried out directly or indirectly. In direct freezing, the droplet is brought into direct contact with a fluid coolant, either by introduction or in a transport step. This guarantees the greatest temperature gradient, i.e. the fastest cooling and freezing rate. In addition, direct introduction into a fluid ensures that the shape of the droplet, either a spherical shape or the shape which has been produced by any preceding shaping process, is largely retained. For the purposes of the present invention, the term “fluid” encompasses all flowable substances, i.e. substances which are not solid and thus, in particular, liquids and gases.

An indirect process can, for example, involve the introduction of a droplet into another fluid which comes into contact with a low-boiling, liquefied coolant or another cooling mechanism via a heat exchanger system. Such an indirect process is advantageous in that the temperature can be controlled better than in the case of direct introduction of the droplet into, for example, liquid nitrogen, in which case the cooling temperature is fixed, In addition, it is conceivable for there to be applications in which it is not desirable to have the extremely high temperature gradient as occurs, for example, in the case of direct introduction into liquid nitrogen.

A process in which the coolant is a cold gas which may either have been cooled by expansion or simply be the vaporization product of a low-boiling, liquefied coolant or have been cooled by heat exchange is explicitly included among cooling processes which can be employed according to the invention.

In general, when the droplet is introduced directly into a low-boiling, liquefied coolant, it is necessary to take account of the pronounced temperature gradient between the droplet to be frozen and the coolant. If the droplet is introduced too rapidly, excessive bubble formation due to vaporizing coolant can result. This can greatly restrict heat transport and finally lead to freezing not occurring as quickly as desired. Uncontrollable secondary agglomeration of individual slowly solidifying droplets can therefore occur. In a preferred embodiment, the number of droplets per unit time is therefore limited so that this agglomeration does not take place or takes place only to an extent which is desired according to the invention. In a further embodiment, forced circulation is induced at the surface of the liquid coolant by stirring, and this likewise leads to controlled agglomeration and thus to controlled droplet size (see Examples).

In a more preferred embodiment, which allows a high throughput, an apparatus which allows fresh liquid nitrogen to be fed in continually and used nitrogen gas to be taken off continually, e.g. by use of a circulation pump, is selected. It is also conceivable, as described, for example, in DE 198 37 600, to use a conveyor belt located in the coolant in order to transport the frozen droplets away from the point of introduction immediately.

Furthermore, in the context of indirect cooling processes, it is also conceivable for the droplet not to come into contact with a liquid but with a solid body cooled by means of a low-boiling, liquefied coolant, e.g. a cooled plate. It is useful to choose plates which have a good thermal conductivity, for example brass or specific, thermally conductive ceramic materials. In contrast to introduction of the droplet into a liquid, the shape of the droplet is drastically flaftened when it is brought into contact with a cooled substrate (e.g. a plate). This can be desirable, e.g. in the production of all-active catalytic bodies having a platelet or pancake shape.

For the purposes of the invention, the term low-boiling, liquefied coolant refers in principle to all coolants which are liquid. In particular, but not exclusively, these are liquefied gases, preferably liquid nitrogen, oxygen, liquid air or liquid helium and also supercritical liquefied gases such as, in particular, CO₂ liquefied under pressure or mixtures of the abovementioned substances, with particular preference being given to liquid nitrogen because it is comparatively safe to handle and is comparatively cheap. Furthermore, liquid nitrogen is nontoxic and can be removed without leaving a residue in a later drying or calcination step.

In principle, however, it is also possible to conceive of other liquids which are suitable for solidifying the droplet at a sufficiently low temperature and in which the droplet does not dissolve or with which the droplet does not react. In particular, but again not exclusively, mention may be made of: mixtures of organic solvents, in particular alcohols, particularly preferably methanol, with dry ice (frozen carbon dioxide) or mixtures which make use of the colligative effect of melting point reduction by mixing, for example water/salt mixtures. Cooling fluids, which can also be referred to as heat-transfer fluids, i.e. liquid media which are brought into contact with a cooling element, are explicitly also encompassed by the term “coolant”. The cooling elements used here can be piezoelectric elements, conventional cooling circuits or refrigerators or processes based on the Joule-Thomson effect, and also all cooling methods which are known to those skilled in the art. The advantages of using indirect processes or processes whose temperature can be controlled quite generally have been mentioned above.

As a result of the droplet or the shaped droplet being brought into contact with a low-temperature coolant, the solvent (e.g. water) freezes and thus stabilizes the shape of the droplet which has been introduced. The droplet is then a “frozen droplet” in the sense of the invention, but not yet the shaped body of the invention. Unlike the shaped body of the invention, the frozen droplet is, although solid, not yet set, i.e. on thawing the droplet would revert to its original state, i.e. a portion of the settable and flowable composition used. The frozen droplet thus has to be cooled so that it cannot melt until the set state has been reached. All transport processes M between the freezing step and the next step, viz, drying and/or calcination, therefore have to be carried out with cooling and/or so rapidly that the frozen droplet cannot thaw or at least does not lose its shape.

The drying step which follows the freezing step comprises removal of the solvent, usually water, from the frozen droplet. It can be carried out using all drying methods known to those skilled in the art which lead to removal of the solvent without loss of the shape. A particularly useful process which is thus preferred for the purposes of the invention is vacuum drying (also known as vacuum sublimation). Here, the frozen solvent is removed from the frozen droplet by sublimation as a result of the application of reduced pressure (vacuum). Sublimation refers to the direct transition from the solid state to the gaseous state. The vacuum is generated by a pump, e.g. a rotary vane pump. To protect both the frozen droplets and the pump, a cold trap is integrated into the apparatus. The water vapour is removed from the apparatus in order to prevent renewed wetting of the frozen droplets (which are still being cooled). This is achieved by condensation on the cold parts of the apparatus (ice condenser). It is possible to use commercially available ice condensers or else, especially on a laboratory scale, cold traps. Sublimation can in principle be carried out at all temperatures at which the solvent is removed from the frozen droplet. The temperature range from 0° C. to minus 30° C. is particularly preferred for the removal of water.

The drying process can at the same time lead to setting of the frozen droplet, in particular when using self-setting binders, e.g. gels or acicular crystals, winch can cure at room temperature. For the purposes of the present invention, setting refers to the formation of stable chemical or physical or physicochemical bonds between the constituents of the settable and flowable composition used as starting substance. These bonds have to be strong enough to guarantee the shape stability of the divided, dried, rewarmed (to at least room temperature) and set droplet during all steps of the process of the invention and during the desired future use. The droplet which has been dried and set in this way and has been warmed at least to a temperature above the melting point of the lowest-melting constituent, e.g. to room temperature, and does not lose its shape, is referred to as shaped body for the purposes of the invention.

The shaped body can then be subjected to further drying steps or else the firing or calcination characteristic for the inorganic shaped body. Calcination is an optional step for shaped bodies which cure during drying and a necessary step for frozen droplets which are not yet cured after drying, i.e. which could disintegrate during further processing steps.

During calcination, the shaped body is fired at temperatures above room temperature in a furnace with introduction of air or under a controlled atmosphere. In a preferred embodiment, the temperatures are in the range from the temperature of the drying step to 1500° C., and in a particularly preferred embodiment from 200° C. to 800° C.

For the purposes of the present invention, controlled atmospheres are: inert gases, reducing atmospheres; for example activation gases containing hydrogen, hydrothermal conditions, in particular steam, oxidizing atmospheres, reactive gases, atmospheres under superatmospheric or subatmospheric pressure and also all possible combinations and/or mixtures of the abovementioned atmospheres.

The shaped body which has been formed in this way, i.e. the shaped body as is obtained after drying or after calcination or after both, can then either be passed as final product to its intended use according to the invention or else be used as first component of a multicomponent shaped body. In multicomponent processes, an application step (1″) is inserted between step (1), i.e. the division of the settable and flowable composition, and step (2), i.e. freezing:

(1″) application step in which a settable and flowable composition is applied to a shaped body.

The shaped body to which the settable and flowable composition is applied can either have been produced by the process of the invention or else be a shaped body produced or obtained in another way. In either case, the shaped body may be regarded as a substrate for the divided settable and flowable composition.

The settable and flowable composition which is applied can be identical to or different from the material of the shaped body to which it is applied. Multiple repetition of the steps (1), (1″), (2) and (3) and use of different settable and flowable compositions in step (1) thus make it possible to build up a shaped body having successive material phases. It should be emphasized that such a multicomponent catalyst is still an all-active catalyst and not a coated catalyst, since the shaped body does not consist of thin films applied to a substrate but instead consists of bulk phases applied in succession.

A further important after-treatment process is impregnation of the shaped body, in particular when the shaped body is porous as a result of appropriate choice of the settable and flowable composition, with a liquid which partly or completely fills the pore volume of the shaped body. In the case of catalytic shaped bodies, particular mention may be made of impregnation with components which are active in respect of the desired reaction, in particular with metal salt solutions.

The shaped body of the invention, obtainable by one of the processes described above in various embodiments, can be used for all purposes for which identical or similar bodies shaped produced according to the state of the art can be employed. This includes but is not limited to use of the shaped bodies of the invention as absorption materials, e.g. in the fields of chromatography and softening of water, or for various embodiments of ion exchangers or chelating agents.

Furthermore, such shaped bodies are employed in the building industry, in particular as building material, but also as insulation material, and also as fillers in the plastics or automobile industry and additionally as storage or filler materials in the food and animal feed industry and the food and animal feed substitutes industry, in particular as diet food, and for applications as carrier materials in the cosmetics industry, as hygiene articles, in the pharmaceutical industry, in particular as carrier and transport materials, and in medical technology.

Shaped bodies which have been obtained by the process of the invention can also be used as high-tech ceramic materials, for example in the fields of high-performance dielectrics, magnetic materials, magnetooptic materials, nonlinear optical materials or high-temperature superconductors.

A particularly important application of the shaped bodies which have been produced according to the invention and can be varied in terms of their size and shape is the production of all-active catalysts. These catalysts can be used in fluidized-bed or fixed-bed applications. In particular, the shaped bodies can be used for combinatorial catalyst research in which a large number, e.g. from 100 to 1000 but preferably a number of thousand to 10⁶, of spherical three-dimensional bodies which preferably have a similar shape are required. As a result of the process of the invention being very flexible compared to the prior art and being able to be carded out particularly simply on a laboratory scale, it is particularly useful for producing libraries of various catalysts in an automated process. Here, both the production of all-active catalysts using a catalytically active settable and flowable composition directly and the production of porous inorganic shaped bodies winch are subsequently impregnated with various catalytically active solutions, e.g. with metal salt solutions, are possible.

The process of the invention and the advantages of the shaped body produced by this process compared to the prior art are illustrated by way of example in the following examples, without restricting the generality of the above description.

### EXAMPLES

### Example 1

### Spray-Dried Reference Sample Produced on an Industrial Scale

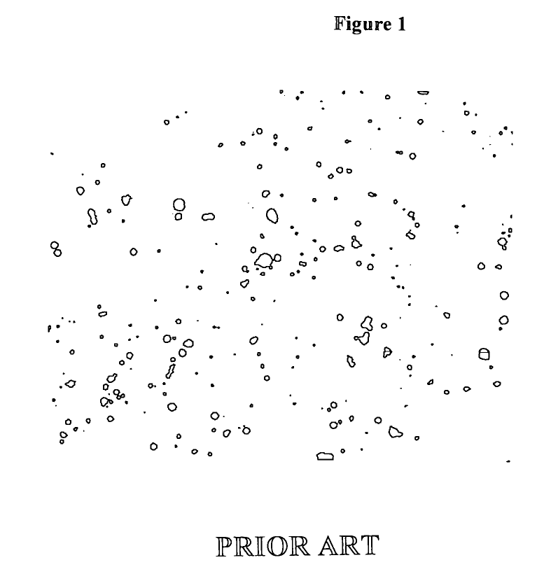

A commercially available spray-dried FCC catalyst comprising ZSM-5 serves as reference sample and represents an inorganic shaped body which has been produced by an industrial spray drying process. In a manner analogous to the other examples, this catalyst, too, was calcined and a target fraction, in this case a fraction having a size distribution from about 50 μm to about 150μ, was sieved out. FIG. 1 shows an optical micrograph of the particles, with the scale being given by the particles themselves.

### Example 2

### Reference Sample Obtained by Microwave Drying

107 g of ZSM-5 (SM-55 from ALSI-Penta®) containing 93.5% of dry matter are slurried in 70 g of deionized water and dispersed for about 1 minute with the aid of a conventional stirring rod. 227.3 g of a basic binder, in this case an aluminium oxyhydroxychloride sol containing 22% of dry matter (Gilufloc-83 from Giulini), are added to this suspension. 101.4 g of kaolin (Thiele) containing 98.6% of dry matter are subsequently added to the mixture while stirring. This suspension is homogenized for 2 minutes by means of the stirring rod and treated in an ultrasonic bath (containing water) for 10 minutes. This mixture will hereinafter be referred to as catalyst suspension I.

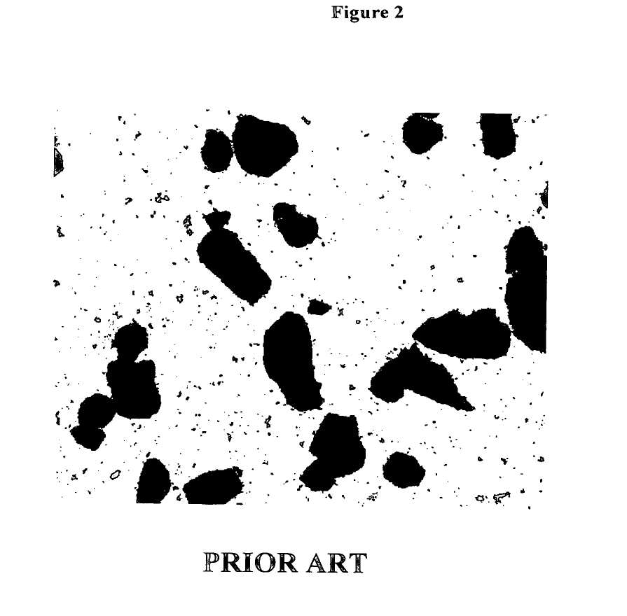

The catalyst suspension I is applied as a thin film to a conventional glass microwave plate and dried at a power of 500 watt until a dry solid cake is formed after about 2-5 minutes. The cake is removed from the glass plate using a spatula and is broken and subsequently calcined at 600° C. for 3 hours in a stream of air. The calcined catalyst is milled in a laboratory mill, and the target fraction having a size range of 100-350 μm is sieved out after each milling step. FIG. 2 shows an optical micrograph of the milled and sieved particles, with the scale again being given by the particles themselves.

### Example 3

### Reference Sample by Spray Granulation Drying on a Laboratory Scale

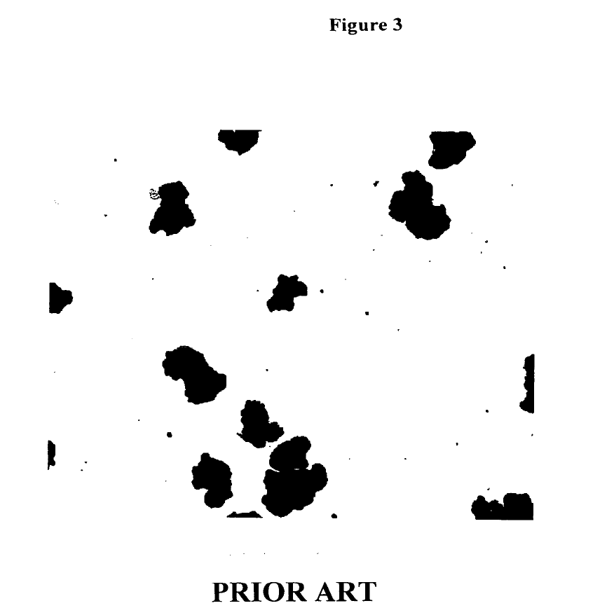

The catalyst suspension I described in Example 2 is diluted to a solids content of 40% by a addition of 190 g of deionized water, dispersed using the stirring rod and treated in an ultrasonic bath (containing water) for 10 minutes. This catalyst suspension II is converted into a dried granular material with the aid of a commercial laboratory-scale spray granulation drying apparatus (Mini-Glatt). Here, a constant volume flow of the suspension of 5 ml/min is conveyed by means of a peristaltic pump through a two-fluid nozzle and atomized by means of a stream of air. A second preheated stream of air is fed in cocurrent from below into the spray chamber to dry and fluidize the growing granules. The temperature of the fluidization air is 80° C., the outlet air temperature is <60° C., the pressure for the atomization is 1.2 bar and that for the fluidization air is 0.9 bar. The yield of granulated material is <50% of the composition introduced, i.e. about half of the dry matter is lost as caking within the apparatus or as fine dust. The samples obtained by spray granulation drying are calcined as described in Example 2. FIG. 3 shows an optical micrograph of the spray-granulated and calcined particles, with the scale again being given by the particles themselves.

### Example 4

### Production of a Catalyst Sample According to the Invention

The catalyst suspension II described in Example 3 above is atomized directly into a Dewar vessel (height 14 cm, external diameter 22 cm) filled with liquid nitrogen by means of a two-fluid nozzle from GLT. The significant process parameters, which can be varied, are the distance of the nozzle from the surface of the liquid nitrogen (1 to 5 cm), the duration of the spray interval (0.1 to 0.5 sec) and the option of stirring the liquid nitrogen. Stirring the liquid nitrogen by means of a conventional magnetic stirrer is found to be sufficient to produce a surface circulation which prevents undesirable agglomeration of the solidifying particles at the point at which the droplets are introduced.

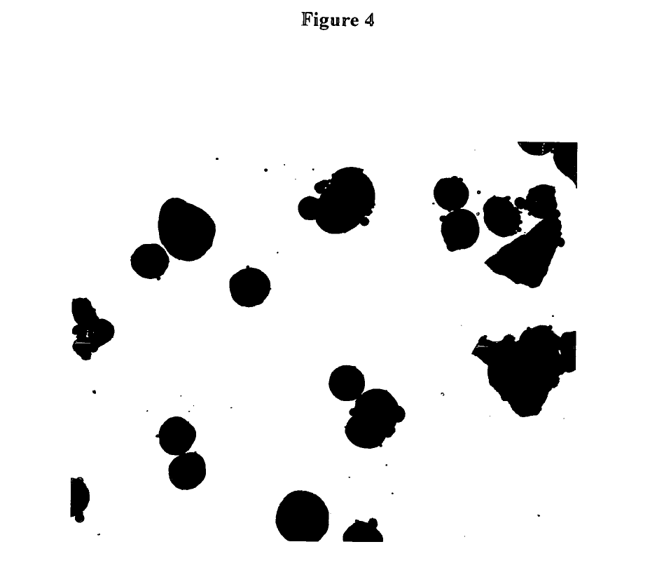

The frozen granular material is subsequently separated off from the liquid nitrogen and freeze-dried at minus 10° C. under reduced pressure in a commercial freeze-drying unit from Christ and subsequently calcined as described in Example 2. FIG. 4 shows an optical micrograph of the frozen, dried and calcined shaped bodies obtained in this way, with the scale being given by the particles (size: 150 to 300 pin), as in the above examples.

The inorganic shaped bodies discussed in Example 1 to 4 can then be examined in terms of their properties relevant to catalytic applications (see Table I).

| | | | Ex. 3: | |
|---|---|---|---|---|
| | | | Fluidized- | Ex. 4: |
| | | Ex. 2 | bed | Process |
| | Ex. 1 | Oven drying | spray | of the |
| Particle | Spray drying | & milling | granulation | invention |
| property: | (commercial) | (laboratory) | (laboratory) | (laboratory) |
| Shape factor | 0.9 | 0.6 | 0.5 | 0.8 |
| Pore volume | 0.27 | 0.20 | 0.23 | 0.82 |
| (water) [ml/g] | | | | |
| Pore volume | 0.07 | 0.06 | 0.08 | 0.28 |
| (hexane) | | | | |
| [ml/g] | | | | |
| Shape | very round | angular, | irregular | largely round |
| (visual) | | sharp-edged | | |

It can clearly be seen that the catalyst according to the invention is in terms of its external shape largely identical to industrially produced and commercially available products (spray drying) and clearly superior to other catalysts produced on a laboratory scale. The shape factor is an approximate measure of equiaxiality of the particles, with a value of 1.0 indicating ideal equiaxiality. It can be seen that although the catalyst according to the invention is not quite as equiaxial as the spray-dried catalyst, it is significantly better than the dried and milled catalyst or the catalyst produced in the fluidized-bed granulator. This assessment is confirmed by visual examination (see FIGS. 1 to 4). In terms of the effectiveness of the catalytic shaped body, indicated in this case by the macroscopic pore volume which is directly proportional to the number of catalytically active centres, the catalyst according to the invention is clearly superior to all of the other catalysts tested, including industrially produced catalysts. The available pore volume of the particles according to the invention is, for example, three times as high as that of all other particles tested.

### Example 5

### Variation of the Diameter of the Shaped Body of the Invention

The aim of this example is to demonstrate the flexibility of the process of the invention with regard to the particle size. Particles having a diameter of from about 0.5 mm to 5 mm are obtained as follows: the catalyst suspension II described above is introduced dropwise directly into liquid nitrogen stirred by means of a magnetic stirrer, using a peristaltic pump and disposable pipettes. At a flow rate of 20 μl/min, it is possible to achieve different sphere diameters by detaching droplets from the pipette by tapping with a finger. The rate of tapping and the diameter of the disposable pipette tip determine the diameter of the spheres formed. The frozen granular material is subsequently separated off from the liquid nitrogen and freeze-dried at minus 10° C. under reduced pressure in a commercial freeze-drying unit from Christ and subsequently calcined as described in Example 2.

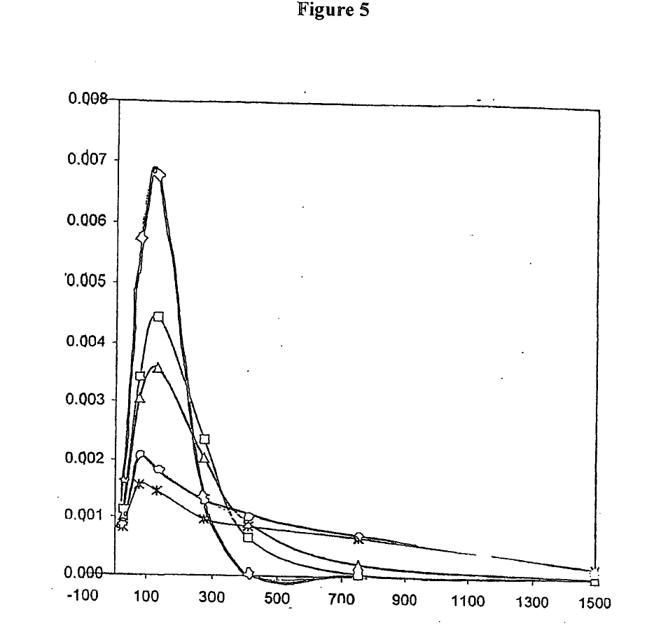

Particles having a smaller diameter, e.g. from 50 to 500 pin, can be obtained using a spray nozzle having an opening of the appropriate diameter and by varying the process parameters such as spray time, distance of the nozzle from the liquid nitrogen and/or presence of a surface circulation in the liquid nitrogen. Thus, for example, FIG. 5 shows the distribution density (vertical axis) as a function of the mean particle size in μm (horizontal axis). Here, the distribution density is the product of mass fraction (from 0 to 1) and particle size interval. As variable parameter, the solids content was varied from 10% (asterisk) to 50% (lozenge) in steps of 10%. The circles refer to a suspension having a solids content of 5%. In this example, the control air pressure was kept constant at 4.8 bar, the spray pressure was 0.7 bar and the liquid pressure was 1 bar.

This example clearly demonstrates a further advantage of the process of the invention: shaped bodies or particles of this size, i.e. several hundred microns and above, can be obtained only by commercial spray drying processes which cannot be reproduced on a laboratory scale and which demand, in particular, very large batch sizes, i.e. they are not suitable at all for producing a large number of different catalysts. Although particles of this size can be produced on a laboratory scale by means of spray granulation processes, the primary particles have a size of only a few microns and can be made larger only by growing-on of further primary particles, as indicated in the description. However, this growing-on process leads, as shown in Example 3, to nonspherical particles (see FIG. 3).

### Example 6

### Impregnation of Freeze-Dried Shaped Bodies According to the Invention

The calcined support samples from Examples 4 and 5 are impregnated with an aqueous metal salt solution in such an amount that 80-100% of the pore volume is filled with impregnation solution and the concentration of metal is 0.13 of metal/100 g of support. The impregnated samples are dried at 80° C. in static air in a drying oven and are subsequently calcined in a stream of air using a temperature programme.

1-41. (canceled)

42. A process for producing a shaped body, comprising the following steps:
dividing a settable and flowable composition into droplets;
freezing the droplets with the aid of a coolant; and
drying or calcining the frozen droplets.

43. A process according to claim 42, wherein the settable and flowable composition contains inorganic constituents.

44. A process according to claim 42, wherein the settable and flowable composition contains a binder.

45. A process according to claim 42, wherein the settable and flowable composition contains at least one further constituent selected from the group consisting of: framework-forming substances, catalytically active substances, auxiliaries, and active ingredients.

46. A process according to claim 42, wherein the settable and flowable composition is in the form of an emulsion, suspension, dispersion, sol, gel, sol/gel, colloid, liquid crystals or a combination of two or more of these states.

47. A process according to claim 42, wherein the settable and flowable composition contains water.

48. A process according to claim 42, wherein the settable and flowable composition is produced using a precursor compound.

49. A process according to claim 48, wherein the precursor compound is selected from the group consisting of alkoxides.

50. A process according to claim 44, wherein the binder is selected from the group consisting of: solid particles having a diameter in the submicron range; inorganic polymers having a tendency to form bridges; metal salts, preferably those having a low content of water of crystallization; polyoxometalates capable of forming gels; pyrogenic or colloidal metal oxides; polymers, in particular hydroxycellulose; graphite and carbon black; alkoxides; organic compounds of the main group elements and transition elements; and combinations of two or more thereof.

51. A process according to claim 50, wherein the binder contains aluminium oxyhydroxychloride sols having a molar ratio of A1:C1 from 1:2 to 2:1.

52. A process according to claim 45, wherein the framework substance is selected from the group consisting of: oxides, oxide mixtures, silicates, aluminosilicates, kaolins, aluminophosphates, mixed oxides of the main group elements and transition elements, and combinations of two or more of these substances.

53. A process according to claim 52, wherein at least one transition element is selected from the group consisting of: alkali metal oxides and alkaline earth metal oxides, glass-forming oxides and mixtures, lipids, amphiphiles, colloids, polymers, and combinations of two or more of these substances.

54. A process according to claim 45, wherein the settable and flowable composition contains at least one catalytically active substance selected from the group consisting of: oxides, amorphous or crystalline silicate phases, and silicate phases in which part of the silicon can be replaced or supplemented by at least one other element.

55. A process according to claim 54, wherein part of the silicon in said silicate phases is replaced or supplemented by at least one element selected from the group consisting of: Al, B, Fe, Ga, V, Zr, Mo, Ti, Zn, Te, Nb or Cr, and any combination of these substances.

56. A process according to claim 54, wherein the catalytically active substance contains at least one zeolite.

57. A process according to claim 45, wherein the optional auxiliary is selected from the group consisting of: lubricants, fluidizers, fillers, surfactants, solvents, surface-active agents, active ingredients and combinations of two or more thereof.

58. A process according to claim 42, wherein the settable and flowable composition is divided into physically separate droplets in a divider.

59. A process according to claim 42, wherein the method of division is selected from the group consisting of: division by dropwise addition, jet cutting, spraying from a nozzle, ultrasonic atomization, extrusion, use of a rotating perforated plate and combinations of two or more thereof.

60. A process according to claim 42, wherein the dividing step is followed directly by a shaping step which shapes the droplet of settable and flowable composition formed by division to form a shaped droplet.

61. A process according to claim 42, wherein a transport step is carried out, said transport step including transport of the settable and flowable composition or of portions thereof from one point in space to another, during which the settable and flowable composition is transported as such or as a droplet or as a frozen droplet or as a shaped body.

62. A process according to claim 61, wherein the transport step employs gravity, mechanical methods, carrier or transport fluids, force fields, sonic fields, electrostatic or magnetic methods or any combinations of two or more thereof.

63. A process according to claim 61, wherein a method used for the transport step is a mechanical method and is carried out with the aid of chutes, impellers, screws, wheels, combs, conveyor belts, “rotating doors” (e.g. paddle wheels), pickers (e.g. pick-and-place devices), tongs, grabbers, carts, capillaries, hoses or any combinations of two or more thereof.

64. A process according to claim 42, wherein the coolant has a temperature and a heat capacity which leads to freezing of the droplets.

65. A process according to claim 42, wherein the coolant is selected from the group consisting of: liquefied inert gases; liquefied noble gases; liquid air; gases liquefied under pressure; expanding gases which cool as a result of the Joule-Thomson effect; cold gases vaporizing from liquefied gases; alcohol/dry ice mixtures; gases, liquids or solids cooled indirectly in a heat exchanger; piezoelectric elements; refrigerators; cooling circuits; and any combination of two or more thereof.

66. A process according to claim 65, wherein at least one of said liquefied inert gases is liquid nitrogen.

67. A process according to claim 65, wherein at least one of said liquefied noble gases is liquid helium.

68. A process according to claim 65, wherein at least one of said gases liquefied under pressure is liquid carbon dioxide.

69. A process according to claim 42, wherein the droplets are introduced directly into a fluid coolant.

70. A process according to claim 69, wherein the droplets are transported away from the point of introduction into the coolant immediately after they have been frozen.

71. A process according to claim 42, wherein at least one drying step is carried out by sublimation.

72. A process according to claim 42, wherein at least one drying step is sufficient for setting the frozen droplet and leads to a cured shaped body.

73. A process according to claim 42, wherein a drying step is followed by a calcining step.

74. A process according to claim 73, wherein calcination is carried out at a temperature in the range from the temperature of the drying step to 1500° C., preferably in the range from 200° C. to 800° C.

75. A process according to claim 42, wherein the drying step or the calcining step take place in a controlled atmosphere selected from the group consisting of: inert gases, reducing atmospheres, hydrothermal conditions, oxidizing atmospheres, reactive gases, atmospheres under superatmospheric or subatmospheric pressure, and combinations of two or more of the said atmospheres.

76. A process according to claim 75 wherein at least one of said reducing atmospheres is an activation gas containing hydrogen.

77. A process according to claim 75 wherein at least one of said hydrothermal conditions is steam.

78. A process according to claim 42, wherein an application step is added between the dividing step and the freezing step, said application step including the application of the settable and flowable composition to a shaped body, with the shaped body functioning as template for the application of the settable and flowable composition.

79. A process according to claim 78, wherein the settable and flowable composition is applied to any shaped body.

80. A process according to claim 78, wherein the settable and flowable composition is applied to a shaped body which has previously been subjected at least once to the processes of claim 42.

81. A process according to claim 78, wherein a multiphase shaped body composed of different materials present on top of one another is built up by use of the same shaped body at least twice and by use of different materials in the dividing step.

82. A process according to claim 42, wherein the dividing step, the freezing step, the drying step or the calcining step is repeated or permutated as often as desired.

83. A process according to claim 42, wherein at least one step is fully automated.

84. A shaped body obtained by a process comprising at least the following steps:
dividing of a settable and flowable composition into droplets;
freezing of the droplets with the aid of a coolant; and
drying or calcining of the frozen droplets.

85. A shaped body according to claim 84, wherein parts of the pore volume or the entire pore volume is impregnated with a catalytically active substance and is optionally subjected to a calcining step.

86. A process according to claim 85 wherein said catalytically active substance is a metal salt solution.

87. Use of a shaped body produced according to claim 84 in catalyst research or catalyst production.

88. Use of a shaped body produced according to claims 84 in combinatorial catalyst research.

89. Use of a shaped body produced according to claim 84 as an ion exchanger; chromatographic material; chelating agent; absorptive material; high-temperature ceramic; magnetoresistive material; superconducting material; dielectric; building material; filler; insulation material; carrier material for products from the food, animal feed and cosmetics industries, in particular as diet food; or as active ingredient supplier or depot material in the pharmaceutical industry.

90. An apparatus for carrying out the processes according to claim 42, wherein said apparatus comprises at least the following: a divider unit for dividing the settable and flowable composition into droplets, a low-temperature cooling apparatus for freezing the droplets, a drying apparatus for drying and setting the frozen droplets, or a calcining apparatus for calcining and setting the frozen droplets.
